(19) United States
(12) Patent Application Publication
(10) Pub. No.: US 2025/0030524 A1
(43) Pub. Date: Jan. 23, 2025

(54) MAPPING BETWEEN ACTIVATED UNIFIED TCI AND TRP ID

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/715,690

(22) PCT Filed: Feb. 23, 2022
(86) PCT No.: PCT/CN2022/077382

§ 371 Date: May 31, 2024

(51) Int. Cl. H04L 5/00; H04W 72/23

(52) U.S. Cl. CPC H04L 5/0094; H04L 5/0035; H04W 72/23

(57) ABSTRACT

Apparatus, methods, and computer program products for mapping between activated unified TCI and TRP are provided. An example method may include receiving, from a network entity, DCI comprising at least one TCI codepoint, the at least one TCI codepoint indicating one or more TCI states mapped to a first TRP associated with the network entity or a second TRP associated with the network entity, the one or more TCI states being associated with at least one activated TCI state. The example method may further include communicating, with the network entity, based on the one or more TCI states.

### TECHNICAL FIELD

The present disclosure relates generally to communication systems, and more particularly, to wireless communication systems with transmission configuration indicator (TCI) states and transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity, downlink control information (DCI) including at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state. The memory and the at least one processor coupled to the memory may be further configured to communicate, with the network entity, based on the one or more TCI states.

In another aspect of the disclosure, a method, a computer-readable medium, and an apparatus at a network entity are provided. The apparatus may include a memory and at least one processor coupled to the memory. The memory and the at least one processor coupled to the memory may be configured to transmit downlink control information (DCI) for a user equipment (UE) including at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state. The memory and the at least one processor coupled to the memory may be further configured to communicate based on the one or more TCI states.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a base station in communication with a UE via a set of beams.

FIG. 5 is a diagram illustrating example multi-TRP (mTRP) DL channels.

FIG. 6 is a diagram illustrating example cyclic mapping and sequential mapping for a UE communicating with two TRPs.

FIG. 7 is a diagram illustrating example DCI repetition, uplink channel repetition, and single frequency network (SFN) downlink channels.

FIG. 8 is a diagram illustrating example communications between a network entity and a UE.

FIG. 9 is a flowchart of a method of wireless communication.

FIG. 10 is a flowchart of a method of wireless communication.

FIG. 11 is a diagram illustrating an example of a hardware implementation for an example apparatus.

### DETAILED DESCRIPTION

When multiple TCIs are activated with multiple TRPs in a TCI codepoint, each TCI may be mapped to a TRP based on aspects provided herein. In some aspects, based on the aspects provided herein if one codepoint (e.g., TCI codepoint in DCI) is mapped to multiple TCI states, the UE may obtain information of association between each TCI and a TRP or corresponding TCI group. The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (NB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

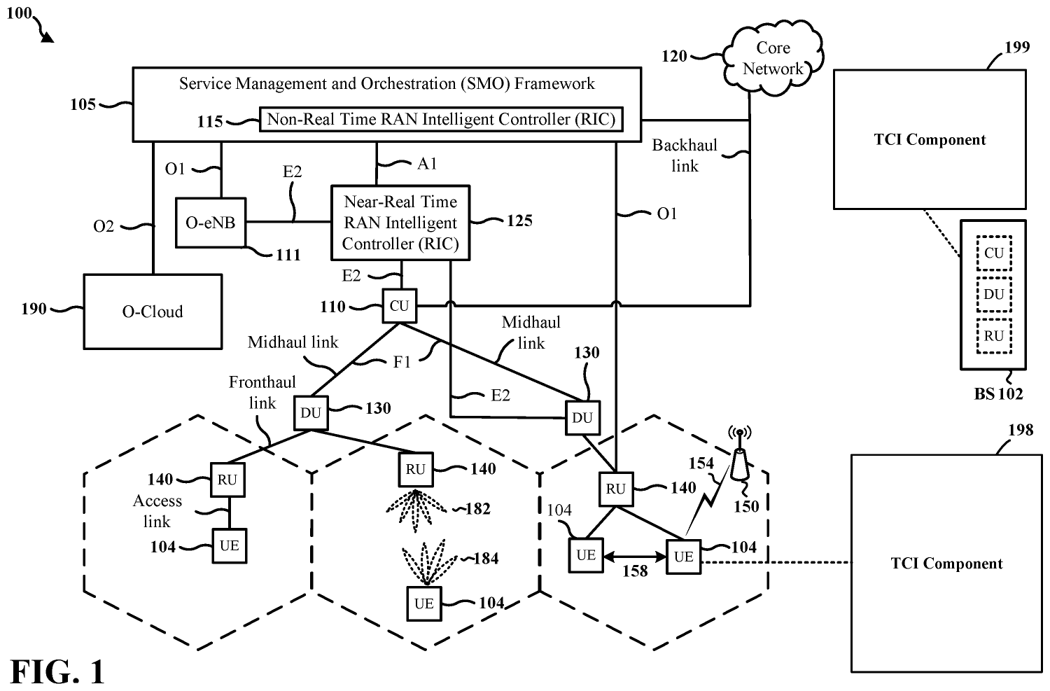

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TCI component 198. In some aspects, the TCI component 198 may be configured to receive, from a network entity, DCI including at least one TCI codepoint, the at least one TCI codepoint indicating one or more TCI states mapped to a first TRP associated with the network entity or a second TRP associated with the network entity. In some aspects, the one or more TCI states may be associated with at least one activated TCI state. In some aspects, the TCI component 198 may be further configured to communicate, with the network entity, based on the one or more TCI states.

In certain aspects, the base station 102 may include a TCI component 199. In some aspects, the TCI component 199 may be configured to transmit DCI for a UE including at least one TCI codepoint, the at least one TCI codepoint indicating one or more TCI states mapped to a first TRP associated with the network entity or a second TRP associated with the network entity. In some aspects, the one or more TCI states may be associated with at least one activated TCI state. In some aspects, the TCI component 199 may be further configured to communicate based on the one or more TCI states.

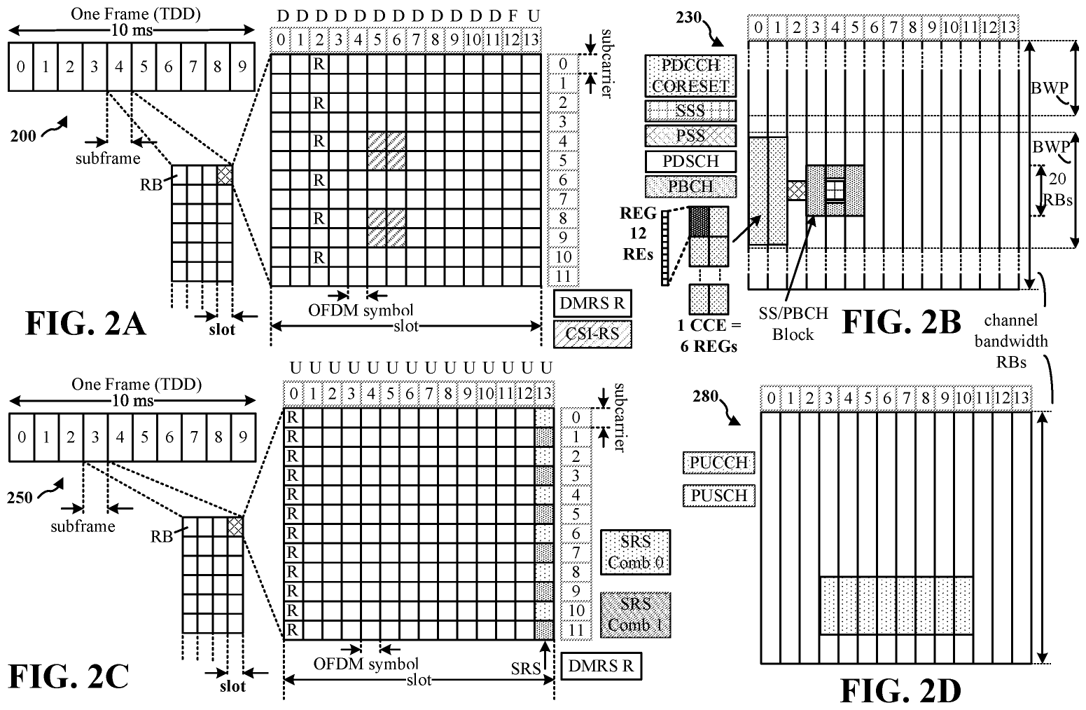

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS

TABLE 1

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

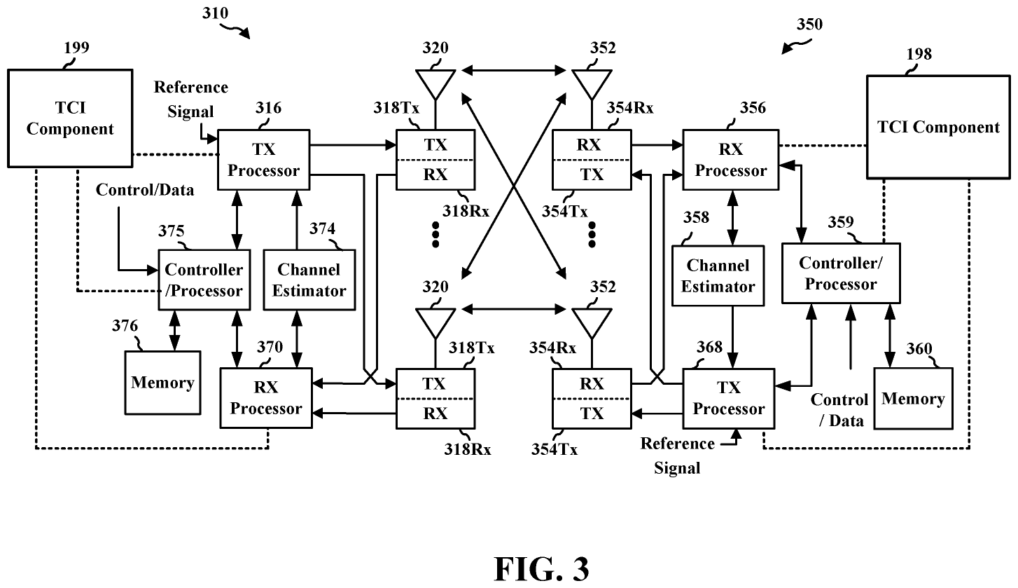

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx.

Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with TCI component 198 of FIG. 1.

At least one of the TX processor 316, the RX processor 370, and the controller/processor 375 may be configured to perform aspects in connection with TCI component 199 of FIG. 1.

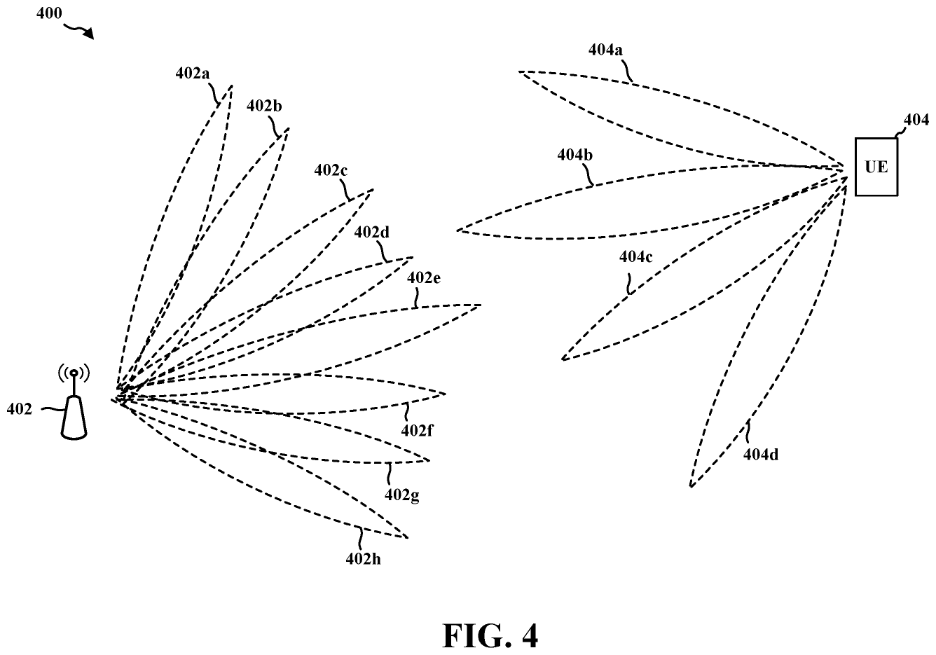

FIG. 4 is a diagram 400 illustrating a base station 402 in communication with a UE 404. Referring to FIG. 4, the base station 402 may transmit a beamformed signal to the UE 404 in one or more of the directions 402a, 402b, 402c, 402d, 402c, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-504d. The base station 402 may receive the beamformed signal from the UE 404 in one or more of the receive directions 402a-502h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same. The term beam may be otherwise referred to as “spatial filter.” Beamforming may be otherwise referred to as “spatial filtering.”

In response to different conditions, the UE 404 may determine to switch beams, e.g., between beams 402a-502h. The beam at the UE 404 may be used for reception of downlink communication and/or transmission of uplink communication. In some examples, the base station 402 may send a transmission that triggers a beam switch by the UE 404. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 402 may indicate a TCI state change, and in response, the UE 404 may switch to a new beam (which may be otherwise referred to as performing a beam switch) according to the new TCI state indicated by the base station 402.

In some wireless communication systems, such as a wireless communication system under a unified TCI framework, a pool of joint DL/UL TCI states may be used for joint DL/UL TCI state updates for beam indication. For example, the base station 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the base station 402 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 4 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based (CB), or non-codebook-based (NCB) UL transmissions.

In some aspects, each of the following DL RSs may share the same indicated TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially quasi-co-located (QCLed) with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCLed with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), a DCI, or a radio resource control (RRC) signal. The TCI state change may cause the UE to find the best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication. A DCI may include one or more TCI codepoints that may each represent one or more TCI states.

In some aspects, a spatial relation change, such as a spatial relation update, may trigger the UE to switch beams. Beamforming may be applied to uplink channels, such as a PUSCH, a PUCCH, or an SRS, or downlink channels, such as PDCCH, PDSCH, or the like. Beamforming may be based on configuring one or more spatial relations between the uplink and downlink signals. Spatial relation indicates that a UE may transmit the uplink signal using the same beam used for receiving the corresponding downlink signal.

In some wireless communication systems, joint TCI for DL and UL may be supported. The source reference signal(s) in M (M being a positive integer) TCIs may provide common QCL information at least for UE-dedicated reception on PDSCH and all or subset of control resource sets (CORESETs) in a component carrier (CC). The source reference signal(s) in N (N being a positive integer) TCIs may provide a reference for determining common UL TX spatial filter(s) at least for dynamic-grant/configured-grant based PUSCH, all or subset of dedicated PUCCH resources in a CC. The UL TX spatial filter may also apply to all SRS resources in resource set(s) configured for antenna switching, codebook-based, or non-codebook-based UL transmissions.

In some wireless communication systems, two separate TCI states, one for DL and one for UL, may be used. For the separate DL TCI, the source reference signal(s) in M TCIs may provide QCL information at least for UE-dedicated reception on PDSCH and for UE-dedicated reception on all or subset of CORESETs in a CC. For the separate UL TCI, the source reference signal(s) in N TCIs may provide a reference for determining common UL TX spatial filter(s) at least for dynamic-grant/configured-grant based PUSCH, all or subset of dedicated PUCCH resources in a CC. The UL TX spatial filter can also apply to all SRS resources in resource set(s) configured for antenna switching, codebook-based, or non-codebook-based UL transmissions.

A wireless device may include M-TRP. Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. The TRPs of the wireless device may be physically separated. For example, TRPs on a wireless device of a vehicle may be located at different locations of the vehicle. Front and rear antenna panels on a vehicle may be separated by 3 meters, 4 meters, or the like. The spacing between TRPs may vary based on the size of a vehicle and/or the number of TRPs associated with the vehicle. Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

A single DCI (sDCI) may be used for scheduling DL or UL channels for mTRP (e.g., two TRPs). Operations or channels associated with sDCI for mTRP may be referred to as “sDCI mTRP.” For example, one DCI may be used for scheduling PDSCHs on two different TRPs for a UE.

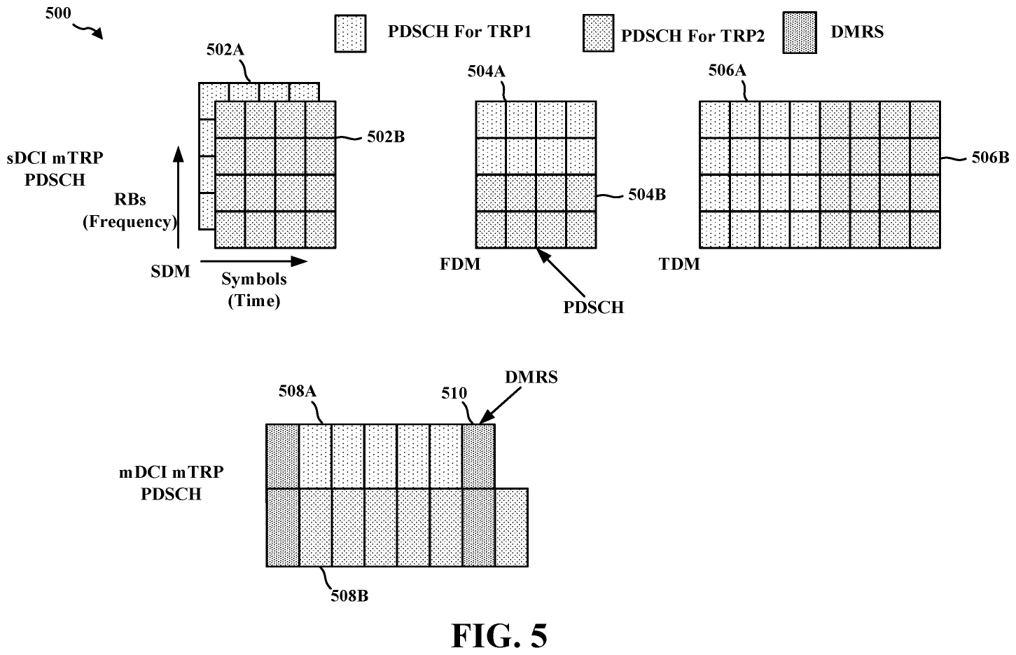

In some aspects, mDCI may be used for DL or UL channels for mTRP. Operations or channels associated with mDCI for mTRP may be referred to as “mDCI mTRP.” For example, two DCIs may be used for scheduling PDSCHs on two different TRPs for a UE. FIG. 5 is a diagram 500 illustrating example mTRP DL channels. As illustrated in FIG. 5, for sDCI mTRP, a first set of PDSCH 502A for a first TRP and a second set of PDSCH 502B for a second TRP may be multiplexed based on spatial division multiplexing (SDM). In some aspects, as illustrated in FIG. 5, for sDCI mTRP, a first set of PDSCH 504A for a first TRP and a second set of PDSCH 504B for a second TRP may be multiplexed based on frequency division multiplexing (FDM). In some aspects, as illustrated in FIG. 5, for sDCI mTRP, a first set of PDSCH 506A for a first TRP and a second set of PDSCH 506B for a second TRP may be multiplexed based on time division multiplexing (TDM). In some aspects, for mDCI mTRP, different DM-RS 510 may be associated with a first set of PDSCH 508A for a first TRP and a second set of PDSCH 508B for a second TRP.

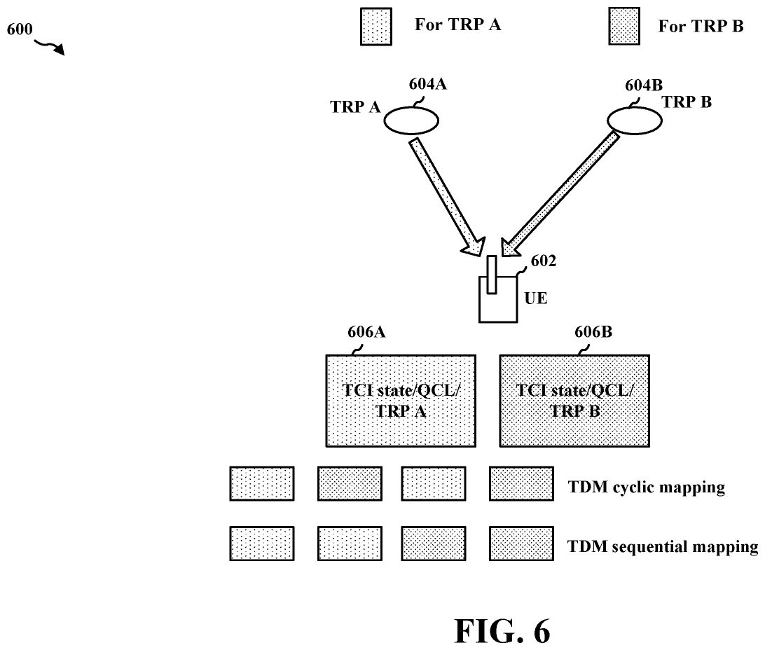

FIG. 6 is a diagram 600 illustrating example cyclic mapping and sequential mapping for a UE communicating with two TRPs. In some aspects, as illustrated in FIG. 6, a UE 602 may communicate with a first TRP 604A and a second TRP 604B. Communications with the first TRP 604A may be associated with a first set of TCI states 606A (and associated QCL) for the first TRP 604A. Communications with the second TRP 604B may be associated with a second set of TCI states 606B (and associated QCL) for the second TRP 604B. In some aspects, the first set of TCI states 606A and the second set of TCI states 606B may be mapped to SS and CORESET based on TDM cyclic (e.g., cycle between one from the first set then one from the second set) mapping. In some aspects, the first set of TCI states 606A and the second set of TCI states 606B may be mapped to SS and CORESET based on TDM sequential (e.g., first set then second set) mapping.

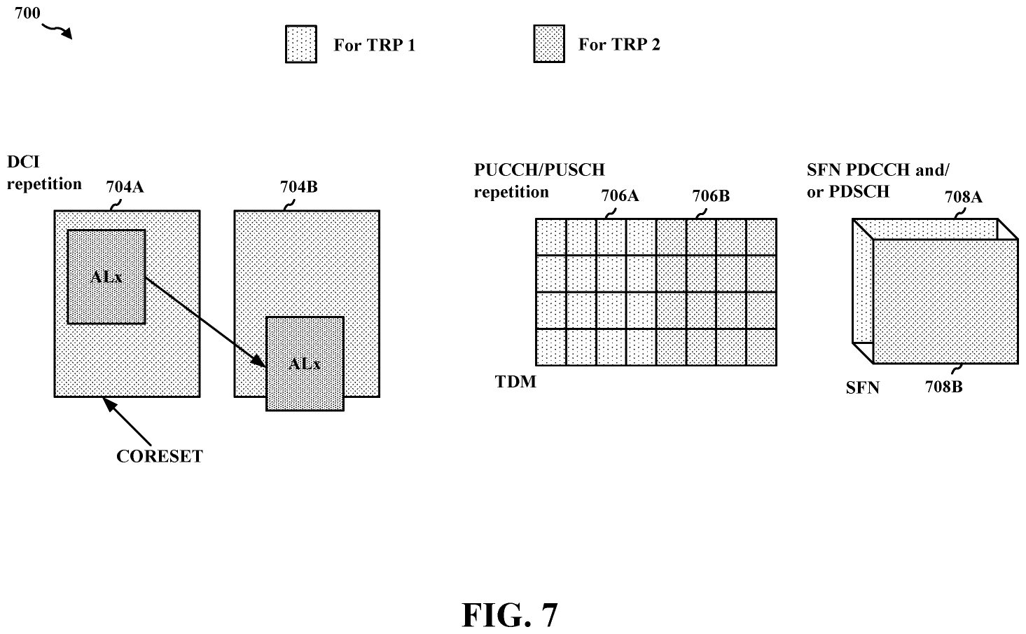

FIG. 7 is a diagram 700 illustrating example DCI repetition, uplink channel repetition, and single frequency network (SFN) downlink channels. For enhancing reliability of transmissions, repetition of DCI transmissions may be used for scheduling DL or UL transmissions. The repetition of DCI transmissions may improve reliability through diversity, by using resources and/or different transmission parameters (such as different TRPs). Repeated DCIs may be in a same or different CORESETs, such as a first CORESET 704A associated with a first TRP and a second CORESET 704B associated with a second TRP. Aggregation level (AL) may indicate number of CCEs for a channel. For example, AL X may indicate X of CCEs for a channel, X being a positive integer. In some aspects, UL channel repetition, such as PUCCH or PUSCH repetition, may be performed based on TDM. For example, UL channels 706A for a first TRP and UL channels 706B for a second TRP may be multiplexed based on TDM. In SFN, channels for different TRPs, such as PDCCH or PDSCH, may be transmitted over a same frequency. For example, as illustrated in FIG. 7, DL channels 708A for a first TRP may be transmitted over a same frequency as DL channels 708B for a second TRP.

For mTRP operations, each TRP may be activated with different TCI types. For example, a TRP may be activated with DL TCI, UL TCI, joint TCI, or DL TCI in combination with UL TCI. When multiple TCIs are activated with multiple TRPs in a TCI codepoint, each TCI may be mapped to a TRP based on aspects provided herein. In some aspects, based on the aspects provided herein if one codepoint (e.g., TCI codepoint in DCI) is mapped to multiple TCI states, the UE may obtain information of association between each TCI and a TRP or corresponding TCI group. For example, if a codepoint is mapped to {DL TCI #10, DL TCI #35, UL TCI #14}, the UE may be aware of the TRP or TCI group with which each of DL TCI #10, DL TCI #35, UL TCI #14 is associated with. In some aspects, the association between activated TCI and TRP identifier (ID) may be used for channel/RS that may use one TCI associated with a particular TRP ID among all TCIs mapped to the selected codepoint. For example, CORESET #1 may be configured to use DL TCI associate with a first TRP. Aspects provided herein may enable a UE to be aware of which activated TCI is associated with the first TRP. In some aspects, TRP ID may be indicated on a per-channel or per-RS basis and may be otherwise referred to as a CORESET pool index, a TCI/beam group ID, or a channel/RS/resource group ID.

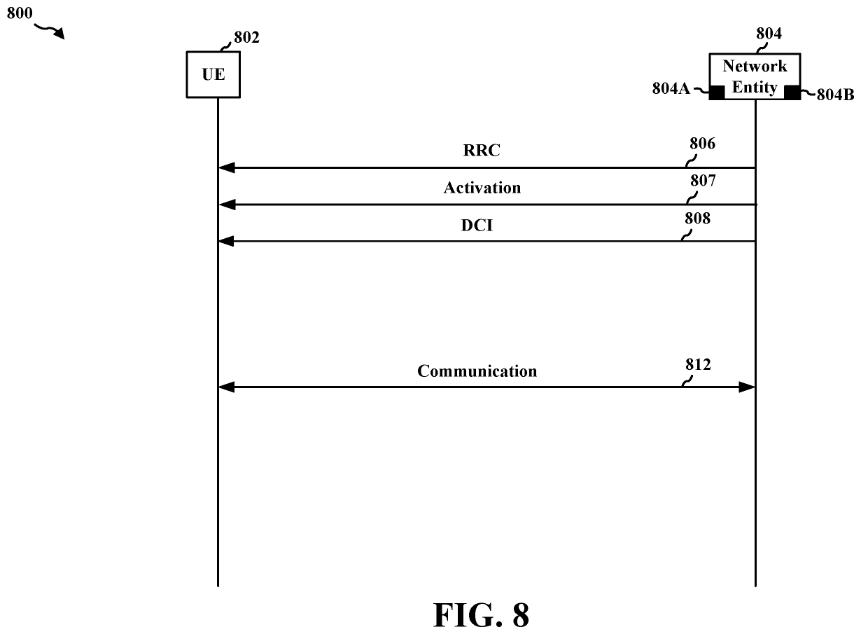

In some aspects, for sDCI mTRP operation, a UE may be activated for one or more TCIs for a TCI codepoint in DCI. FIG. 8 is a diagram 800 illustrating example communications between a network entity 804 and a UE 802. The network entity 804 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 804 may include a first TRP 804A and a second TRP 804B.

In some aspects, the UE 802 may receive a DCI 808 from the network entity 804. The DCI 808 may include one or more TCI codepoints for the first TRP 804A and the second TRP 804B. In some aspects, the DCI 808 may indicate one TCI codepoint of one or more TCI codepoints. In some aspects, the UE 802 may be indicated (e.g., at 807) with one or more TCIs for the one or more TCI codepoints. In some aspects, indicating the one or more TCIs may be based on an activation 807 from the network entity 804, which may be an activation MAC-CE from the network entity 804. In some aspects, the activation 807 may activate one or more TCI codepoints mapped with one or more TCIs in a TCI list configured via RRC signaling at 806. In some aspects, a subset (e.g., one) TCI codepoint of the one or more activated codepoints may be indicated by the DCI 808. In some aspects, the RRC signaling at 806 may configure a TCI list for the UE 802. In some aspects, the RRC signaling at 806 may also configure an association between TRP and TCI. In some aspects, the activation MAC-CE may include a field C_x representing a corresponding TCI that may be activated for the xth TCI codepoint (x being an integer, and x=0,1,2 . . . ). An example of the activation MAC-CE is shown in Table 2 below:

TABLE 2

| | |
|---|---|
| C_0 = 1 | DL TCI #5 |
| C_0 = 1 | UL TCI #10 |
| C_0 = 0 | Joint TCI #15 |
| C_1 = 1 | Joint TCI #7 |
| C_1 = 0 | DL TCI #29 |
| C_2 = 0 | Joint TCI #35 |
| C_3 = 1 | Joint TCI #2 |
| C_3 = 1 | DL TCI #43 |
| C_3 = 0 | UL TCI #48 |

In some aspects, C_x =1 may represent the next indicated TCI (e.g.in the next octet, or in the next row) belongs to the same TCI codepoint. In some aspects, C_x =0 may represent the next indicated TCI (e.g.in the next octet, or in the next row) belongs to the next TCI codepoint. For example, the TCI codepoint corresponds to C_1 indicates a joint TCI of ID 7 and a DL TCI of ID 29. In some aspects, each TCI in a TCI codepoint may be one of a DL TCI, a UL TCI, or a joint TCI. In some aspects, DL TCI and UL TCI may be paired in a TCI code point. In some aspects, a TCI codepoint may have one paired DL TCI and UL TCI, in addition to a DL TCI, a UL TCI, a joint TCI, or another paired DL TCI and UL TCI.

In some aspects, for sDCI based mTRP operation, for one codepoint mapped to multiple unified TCI states, the association between each TCI and corresponding TRP ID may be based on an implicit rule defined based on the type and the order of the TCI among all TCIs mapped to the same codepoint. For example, if there is one single joint TCI in a codepoint, if the joint TCI is the first TCI in the codepoint, the joint TCI may be mapped to the first TRP 804A, and the remaining TCI(s) may be mapped to the second TRP 804B. In some aspects, if the joint TCI is not the first TCI in the codepoint, the joint TCI may be mapped to the second TRP 804B and the remaining TCI(s) may be mapped to the first TRP 804A. In some aspects, if there are two joint TCIs, the first joint TCI may be mapped to the first TRP 804A and the second joint TCI may be mapped to the second TRP 804B. In some aspects, the first DL TCI and the first UL TCI before the second DL TCI (if exists) may be mapped to the first TRP 804A and the remaining TCI(s) may be mapped to the second TRP 804B.

In some aspects, for sDCI based mTRP operation, for one codepoint mapped to multiple unified TCI states, the association between each TCI and corresponding TRP ID may be based on explicit signaling. In some aspects, each activated TCI may be signaled with associated TRP ID. In some aspects, the TRP ID may be signaled in the DCI 808, RRC signaling 806, or activation 807. For example, the TRP ID may be signaled in each RRC configured TCI state IE, in TCI activation MAC-CE (e.g., activation 807), or in the TCI indication DCI (e.g., the DCI 808). An example of the activation MAC-CE including the TRP ID is shown in Table 3 below:

TABLE 3

| | | |
|---|---|---|
| C_0 = 1 | DL TCI #5 | TRP #1 |
| C_0 = 1 | UL TCI #10 | TRP #1 |
| C_0 = 0 | Joint TCI #15 | TRP #2 |
| C_1 = 1 | Joint TCI #7 | TRP #1 |
| C_1 = 0 | DL TCI #29 | TRP #1 |
| C_2 = 0 | Joint TCI #35 | TRP #2 |
| C_3 = 1 | Joint TCI #2 | TRP #1 |
| C_3 = 1 | DL TCI #43 | TRP #1 |
| C_3 = 0 | UL TCI #48 | TRP #2 |

In some aspects, for sDCI based mTRP operation, for one codepoint mapped to multiple unified TCI states, the association between each TCI and corresponding TRP based on a table configured without network entity signaling, or signaled from the network entity 804 to the UE 802. An example table is shown in Table 4 below:

TABLE 4

| | | | |
|---|---|---|---|
| TCI for 1^{st} | TCI for | TCI | |
| TRP or sTRP | 2^{nd} TRP | codepoint | Row # |

| | | | | | |
|---|---|---|---|---|---|
| D | | | | D | 1 |
| | U | | | U | 2 |
| D | U | | | DU | 3 |
| J | | | | J | 4 |
| D | | D | | DD | 5 |
| D | | | U | DU−>DNU | 6 |
| D | | D | U | DDU | 7 |
| D | | J | | DJ | 8 |
| | U | D | | UD | 9 |
| | U | | U | UU | 10 |
| | U | D | U | UDU | 11 |
| | U | J | | UJ | 12 |
| D | U | D | | DUD | 13 |
| D | U | | U | DUU | 14 |
| D | U | D | U | DUDU | 15 |
| D | U | J | | DUJ | 16 |
| J | | D | | JD | 17 |
| J | | | U | JU | 18 |
| J | | D | U | JDU | 19 |
| J | | J | | JJ | 20 |

In some aspects, D may represent DL TCI, U may represent UL TCI, and J may represent joint TCI. As an example, DDU for a TCI codepoint may represent that the first TRP 804A is indicated with a DL TCI, and the second TRP 804B is indicated with a DL TCI and a UL TCI. As another example, DUD for a TCI codepoint may represent that the first TRP 804A is indicated with a paired DL TCI and UL TCI and the second TRP 804B is indicated with a DL TCI. The TCI codepoint may also indicate TCIs for single TRP operation, where TCIs for either the first TRP 804A or the second TRP 804B may be activated in a TCI codepoint, and the indicated TCIs in such TCI codepoints may be a DL TCI, a UL TCI, a joint TCI, or a paired DL and UL TCI. The UE may determine the association between the TCIs and TRPs based on the order of TCIs in a TCI codepoint specified by the table. For example, when a TCI codepoint indicates an order of DUD, the UE may associate a paired DL TCI and UL TCI for the first TRP 804A, and associate a DL TCI for the second TRP 804B, and when a TCI codepoint indicates an order of DDU, the UE may associate a DL TCI for the first TRP 804A, and associate a paired DL TCI and UL TCI for the second TRP 804B. When there may be a collision (e.g., collision between the case of a paired DL TCI and UL TCI for a single TRP in row 3 of DU and the case of a DL TCI for the first TRP 804A and a UL TCI for the second TRP 804B in row 6 of DNU), in some aspects, one of the two cases (row 3 and row 6) may be predetermined to be allowed to be indicated to the UE 802. In some aspects, there may be an additional field in TCI codepoint to distinguish between the two cases (row 3 and row 6).

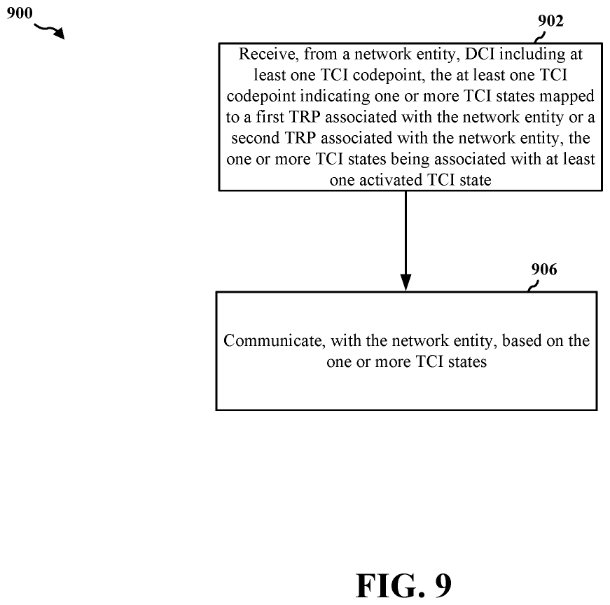

FIG. 9 is a flowchart 900 of a method of wireless communication. The method may be performed by a UE (e.g., the UE 104, the UE 802; the apparatus 1104).

At 902, the UE may receive, from a network entity, DCI including at least one TCI codepoint. The at least one TCI codepoint may indicate one or more TCI states mapped to a first TRP associated with the network entity or a second TRP associated with the network entity. For example, the UE 802 may receive, from a network entity 804, DCI 808 including at least one TCI codepoint. In some aspects, the one or more TCI states may be associated with at least one activated TCI state (e.g., based on an activation 807). In some aspects, 902 may be performed by TCI component 198. In some aspects, each TCI state of the one or more TCI states may be one of: a DL TCI state, an UL TCI state, or a joint TCI state. In some aspects, the one or more TCI states indicated by the at least one TCI codepoint may include one or more paired DL and UL TCI states. In some aspects, a TCI codepoint may have one paired DL TCI and UL TCI, in addition to a DL TCI, a UL TCI, a joint TCI, or another paired DL TCI and UL TCI. In some aspects, each TCI state of the one or more TCI states may be associated with a first TRP ID of the first TRP or a second TRP ID of the second TRP based on a TCI mapping. In some aspects, the TCI mapping may be implicit and based on one or more types of the one or more TCI states and an order of the one or more TCI states. In some aspects, the one or more TCI states may include a single joint TCI state, and the single joint TCI state may be associated with the first TRP ID if the single joint TCI state is a first TCI state in the one or more TCI states, and the single joint TCI state may be associated with the second TRP ID if the single joint TCI state is not the first TCI state in the one or more TCI states. In some aspects, the one or more TCI states include a first joint TCI state and a second joint TCI state, and the first joint TCI state may be associated with the first TRP ID and the second joint TCI state may be associated with the second TRP ID. In some aspects, the one or more TCI states may include a first DL TCI state and a first UL TCI state, and the first DL TCI state and the first UL TCI state are associated with the first TRP ID. In some aspects, the TCI mapping may be signaled for each TCI state of the one or more TCI states based on RRC configured TCI state information element (IE) or an activation MAC-CE. In some aspects, the TCI mapping may be signaled for each TCI state of the one or more TCI states based on the DCI. In some aspects, the TCI mapping may be based on a table including a plurality of fields for at least one of: the at least one TCI codepoint, the one or more TCI states mapped to the first TRP, or the one or more TCI states mapped to the second TRP.

At 906, the UE may communicate, with the network entity, based on the one or more TCI states. For example, the UE 802 may communicate (e.g., by exchanging communication 812), with the network entity 804, based on the one or more TCI states. In some aspects, 906 may be performed by TCI component 198. In some aspects, the at least one activated TCI state of the one or more TCI states may be activated based on an activation MAC-CE (e.g., the activation 807). In some aspects, the activation MAC-CE may include one or more fields representing an association between the at least one activated TCI state and the at least one TCI codepoint.

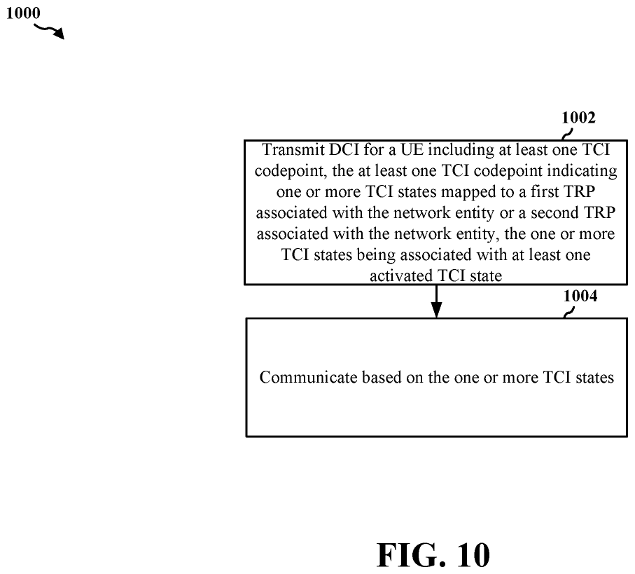

FIG. 10 is a flowchart 1000 of a method of wireless communication. The method may be performed by a network entity (e.g., the base station 102/180; the network entity 804, the network entity 1102).

At 1002, the network entity may transmit DCI for a UE including at least one TCI codepoint. The at least one TCI codepoint may indicate one or more TCI states mapped to a first TRP associated with the network entity or a second TRP associated with the network entity. For example, the network entity 804 may transmit DCI 808 for a UE 802 including at least one TCI codepoint. In some aspects, the one or more TCI states may be associated with at least one activated TCI state (e.g., based on an activation 807). In some aspects, 1002 may be performed by TCI component 199. In some aspects, each TCI state of the one or more TCI states may be one of: a DL TCI state, an UL TCI state, or a joint TCI state. In some aspects, the one or more TCI states indicated by the at least one TCI codepoint may include one or more paired DL and UL TCI states. In some aspects, a TCI codepoint may have one paired DL TCI and UL TCI, in addition to a DL TCI, a UL TCI, a joint TCI, or another paired DL TCI and UL TCI. In some aspects, each TCI state of the one or more TCI states may be associated with a first TRP ID of the first TRP or a second TRP ID of the second TRP based on a TCI mapping. In some aspects, the TCI mapping may be implicit and based on one or more types of the one or more TCI states and an order of the one or more TCI states. In some aspects, the one or more TCI states may include a single joint TCI state, and the single joint TCI state may be associated with the first TRP ID if the single joint TCI state is a first TCI state in the one or more TCI states, and the single joint TCI state may be associated with the second TRP ID if the single joint TCI state is not the first TCI state in the one or more TCI states. In some aspects, the one or more TCI states include a first joint TCI state and a second joint TCI state, and the first joint TCI state may be associated with the first TRP ID and the second joint TCI state may be associated with the second TRP ID. In some aspects, the one or more TCI states may include a first DL TCI state and a first UL TCI state, and the first DL TCI state and the first UL TCI state are associated with the first TRP ID. In some aspects, the TCI mapping may be signaled for each TCI state of the one or more TCI states based on RRC configured TCI state information element (IE) or an activation MAC-CE. In some aspects, the TCI mapping may be signaled for each TCI state of the one or more TCI states based on the DCI. In some aspects, the TCI mapping may be based on a table including a plurality of fields for at least one of: the at least one TCI codepoint, the one or more TCI states mapped to the first TRP, or the one or more TCI states mapped to the second TRP.

At 1004, the network entity may communicate based on the one or more TCI states. For example, the network entity 804 may communicate (e.g., by exchanging communication 812) based on the one or more TCI states. In some aspects, 1004 may be performed by TCI component 199. In some aspects, the at least one activated TCI state may be based on an activation MAC-CE (e.g., the activation 807). In some aspects, the activation MAC-CE may include one or more fields representing an association between the at least one activated TCI state and the at least one TCI codepoint.

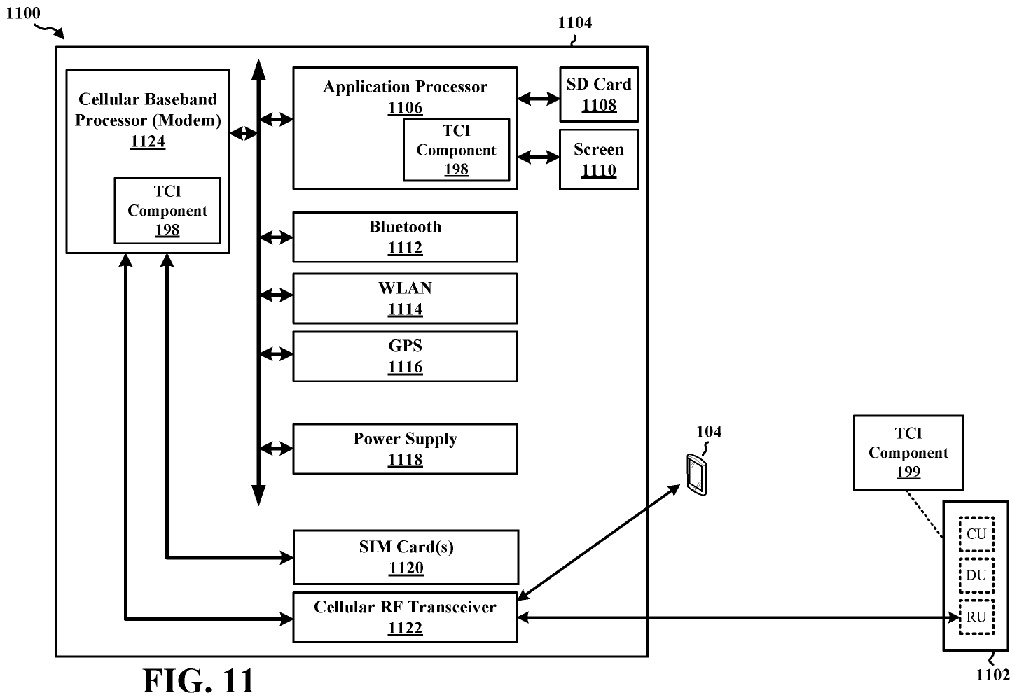

FIG. 11 is a diagram 1100 illustrating an example of a hardware implementation for an apparatus 1104 and a network entity 1102. The apparatus 1104 may be a UE, a component of a UE, or may implement UE functionality. The network entity 1102 may be a BS, a component of a BS, or may implement BS functionality. In some aspects, the apparatus 1104 may include a cellular baseband processor 1124 (also referred to as a modem) coupled to a cellular RF transceiver 1122. In some aspects, the apparatus 1104 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1124 communicates through the cellular RF transceiver 1122 with the UE 104 and/or with an RU associated with the network entity 1102. The RU is either part of the network entity 1102 or is in communication with the network entity 1102. The network entity 1102 may include one or more of the CU, DU, and the RU. The cellular baseband processor 1124 and the application processor 1106 may each include a computer-readable medium/memory. Each computer-readable medium/memory may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the TCI component 198 may be configured to receive, from a network entity, DCI including at least one TCI codepoint, the at least one TCI codepoint indicating one or more TCI states mapped to a first TRP associated with the network entity or a second TRP associated with the network entity, the one or more TCI states being associated with at least one activated TCI state. In some aspects, the TCI component 198 may be further configured to communicate, with the network entity, based on the one or more TCI states. The TCI component 198 may be within the cellular baseband processor 1124, the application processor 1106, or both the cellular baseband processor 1124 and the application processor 1106. The TCI component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving, from a network entity, DCI including at least one TCI codepoint, the at least one TCI codepoint indicating one or more TCI states mapped to a first TRP associated with the network entity or a second TRP associated with the network entity, the one or more TCI states being associated with at least one activated TCI state. In some aspects, the apparatus 1104, and in particular the cellular baseband processor 1124 and/or the application processor 1106 may further include means for communicating, with the network entity, based on the one or more TCI states. The means may be the TCI component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, in some aspects, the TCI component 199 may be configured to transmit DCI for a UE including at least one TCI codepoint, the at least one TCI codepoint indicating one or more TCI states mapped to a first TRP associated with the network entity or a second TRP associated with the network entity, the one or more TCI states being associated with at least one activated TCI state. In some aspects, the TCI component 199 may be further configured to communicate based on the one or more TCI states. The TCI component 199 may be within one or more processors (e.g., BBU(s)) of one or more of the CU, DU, and the RU. The TCI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting DCI for a UE including at least one TCI codepoint, the at least one TCI codepoint indicating one or more TCI states mapped to a first TRP associated with the network entity or a second TRP associated with the network entity, the one or more TCI states being associated with at least one activated TCI state. The network entity 1102 may further include means for communicating based on the one or more TCI states. The means may be the TCI component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for communication at a UE, including: receiving, from a network entity, DCI including at least one TCI codepoint, the at least one TCI codepoint indicating one or more TCI states mapped to a first TRP associated with the network entity or a second TRP associated with the network entity, the one or more TCI states being associated with at least one activated TCI state; and communicating, with the network entity, based on the one or more TCI states.

Aspect 2 is the method of aspect 1, where the at least one activated TCI state is based on an activation MAC-CE.

Aspect 3 is the method of any of aspects 1-2, where the activation MAC-CE includes one or more fields representing an association between the at least one activated TCI state and the at least one TCI codepoint.

Aspect 4 is the method of any of aspects 1-3, where each TCI state of the one or more TCI states is one of: a DL TCI state, an UL TCI state, or a joint TCI state.

Aspect 5 is the method of any of aspects 1-4, where the one or more TCI states indicated by the at least one TCI codepoint include one or more paired DL and UL TCI states.

Aspect 6 is the method of any of aspects 1-5, where each TCI state of the one or more TCI states is associated with a first TRP ID of the first TRP or a second TRP ID of the second TRP based on a TCI mapping.

Aspect 7 is the method of any of aspects 6, where the TCI mapping is implicit and based on one or more types of the one or more TCI states and an order of the one or more TCI states.

Aspect 8 is the method of any of aspects 1-7, where the one or more TCI states include a single joint TCI state, where the single joint TCI state is associated with the first TRP ID if the single joint TCI state is a first TCI state in the one or more TCI states, and where the single joint TCI state is associated with the second TRP ID if the single joint TCI state is not the first TCI state in the one or more TCI states.

Aspect 9 is the method of any of aspects 1-8, where the one or more TCI states include a first joint TCI state and a second joint TCI state, and where the first joint TCI state is associated with the first TRP ID and the second joint TCI state is associated with the second TRP ID.

Aspect 10 is the method of any of aspects 1-9, where the one or more TCI states include a first DL TCI state and a first UL TCI state, and where the first DL TCI state and the first UL TCI state are associated with the first TRP ID.

Aspect 11 is the method of any of aspects 1-6, where the TCI mapping is signaled for the each TCI state of the one or more TCI states based on RRC configured TCI state information element (IE) or an activation MAC-CE.

Aspect 12 is the method of any of aspects 1-6, where the TCI mapping is signaled for the each TCI state of the one or more TCI states based on the DCI.

Aspect 13 is the method of any of aspects 1-6 and 11-12, where the TCI mapping is based on a table including a plurality of fields for at least one of: the at least one TCI codepoint, the one or more TCI states mapped to the first TRP, or the one or more TCI states mapped to the second TRP.

Aspect 14 is the method of any of aspects 1-13, where the method is performed by an apparatus at a UE including a memory and at least one processor coupled to the memory and at least one of a transceiver or an antenna coupled to the at least one processor.

Aspect 15 is a method for communication at a network entity, including: transmitting DCI for a UE including at least one TCI codepoint, the at least one TCI codepoint indicating one or more TCI states mapped to a first TRP associated with the network entity or a second TRP associated with the network entity, the one or more TCI states being associated with at least one activated TCI state; and communicating based on the one or more TCI states.

Aspect 16 is the method of aspect 15, where the at least one activated TCI state is based on an activation MAC-CE.

Aspect 17 is the method of any of aspects 15-16, where the activation MAC-CE includes one or more fields representing an association between the at least one activated TCI state and the at least one TCI codepoint.

Aspect 18 is the method of any of aspects 15-17, where each TCI state of the one or more TCI states is one of: a DL TCI state, an UL TCI state, or a joint TCI state.

Aspect 19 is the method of any of aspects 15-18, where the one or more TCI states indicated by the at least one TCI codepoint includes one or more paired DL and UL TCI states.

Aspect 20 is the method of any of aspects 15-19, where each TCI state of the one or more TCI states is associated with a first TRP ID of the first TRP or a second TRP ID of the second TRP based on a TCI mapping.

Aspect 21 is the method of any of aspects 15-20, where the TCI mapping is implicit and based on one or more types of the one or more TCI states and an order of the one or more TCI states.

Aspect 22 is the method of any of aspects 15-21, where the one or more TCI states include a single joint TCI state, where the single joint TCI state is associated with the first TRP ID if the single joint TCI state is a first TCI state in the one or more TCI states, and where the single joint TCI state is associated with the second TRP ID if the single joint TCI state is not the first TCI state in the one or more TCI states.

Aspect 23 is the method of any of aspects 15-22, where the one or more TCI states include a first joint TCI state and a second joint TCI state, and where the first joint TCI state is associated with the first TRP ID and the second joint TCI state is associated with the second TRP ID.

Aspect 24 is the method of any of aspects 23, where the one or more TCI states include a first DL TCI state and a first UL TCI state, and where the first DL TCI state and the first UL TCI state are associated with the first TRP ID.

Aspect 25 is the method of any of aspects 15-20, where the TCI mapping is signaled for the each TCI state of the one or more TCI states based on RRC configured TCI state information element (IE) or an activation MAC-CE.

Aspect 26 is the method of any of aspects 15-20, where the TCI mapping is signaled for the each TCI state of the one or more TCI states based on the DCI.

Aspect 27 is the method of any of aspects 15-20 and 25-26, where the TCI mapping is based on a table including a plurality of fields for at least one of: the at least one TCI codepoint, the one or more TCI states mapped to the first TRP, or the one or more TCI states mapped to the second TRP.

Aspect 28 is the method of any of aspects 15-27, where the method is performed by an apparatus at a network entity including a memory and at least one processor coupled to the memory and at least one of a transceiver or an antenna coupled to the at least one processor.

Aspect 29 is an apparatus for wireless communication at a UE including a memory and at least one processor coupled to the memory and, based at least in part on information stored in the memory, the at least one processor is configured to perform a method in accordance with any of aspects 1-14. The apparatus may include at least one of a transceiver or an antenna coupled to the at least one processor.

Aspect 30 is an apparatus for wireless communications, including means for performing a method in accordance with any of aspects 1-14.

Aspect 31 is a non-transitory computer-readable medium including instructions that, when executed by an apparatus, cause the apparatus to perform a method in accordance with any of aspects 1-14.

Aspect 32 is an apparatus for wireless communication at a network entity including a memory and at least one processor coupled to the memory and, based at least in part on information stored in the memory, the at least one processor is configured to perform a method in accordance with any of aspects 15-28. The apparatus may include at least one of a transceiver or an antenna coupled to the at least one processor.

Aspect 33 is an apparatus for wireless communications, including means for performing a method in accordance with any of aspects 15-28.

Aspect 34 is a non-transitory computer-readable medium including instructions that, when executed by an apparatus, cause the apparatus to perform a method in accordance with any of aspects 15-28.

What is claimed is:

1. An apparatus for communication at a user equipment (UE), comprising:
memory; and
at least one processor coupled to the memory and, based at least in part on information stored in the memory, the at least one processor is configured to:
receive, from a network entity, downlink control information (DCI) comprising at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state; and
communicate, with the network entity, based on the one or more TCI states.

2. The apparatus of claim 1, wherein the at least one activated TCI state is based on an activation medium access control (MAC) control element (MAC-CE).

3. The apparatus of claim 2, wherein the activation MAC-CE comprises one or more fields representing an association between the at least one activated TCI state and the at least one TCI codepoint.

4. The apparatus of claim 1, wherein each TCI state of the one or more TCI states is one of: a downlink (DL) TCI state, an uplink (UL) TCI state, or a joint TCI state.

5. The apparatus of claim 4, wherein the one or more TCI states indicated by the at least one TCI codepoint comprise one or more paired DL and UL TCI states.

6. The apparatus of claim 1, wherein each TCI state of the one or more TCI states is associated with a first TRP identifier (ID) of the first TRP or a second TRP ID of the second TRP based on a TCI mapping.

7. The apparatus of claim 6, wherein the TCI mapping is implicit and based on one or more types of the one or more TCI states and an order of the one or more TCI states.

8. The apparatus of claim 7, wherein the one or more TCI states include a single joint TCI state, wherein the single joint TCI state is associated with the first TRP ID if the single joint TCI state is a first TCI state in the one or more TCI states, and wherein the single joint TCI state is associated with the second TRP ID if the single joint TCI state is not the first TCI state in the one or more TCI states.

9. The apparatus of claim 7, wherein the one or more TCI states include a first joint TCI state and a second joint TCI state, and wherein the first joint TCI state is associated with the first TRP ID and the second joint TCI state is associated with the second TRP ID.

10. The apparatus of claim 7, wherein the one or more TCI states include a first downlink (DL) TCI state and a first uplink (UL) TCI state, and wherein the first DL TCI state and the first UL TCI state are associated with the first TRP ID.

11. The apparatus of claim 6, wherein the TCI mapping is signaled for the each TCI state of the one or more TCI states based on radio resource control (RRC) configured TCI state information element (IE) or an activation medium access control (MAC) control element (MAC-CE).

12. The apparatus of claim 6, wherein the TCI mapping is signaled for the each TCI state of the one or more TCI states based on the DCI.

13. The apparatus of claim 6, wherein the TCI mapping is based on a table including a plurality of fields for at least one of: the at least one TCI codepoint, the one or more TCI states mapped to the first TRP, or the one or more TCI states mapped to the second TRP.

14. The apparatus of claim 1, further comprising at least one of a transceiver or an antenna coupled to the at least one processor.

15. An apparatus for communication at a network entity, comprising:
memory; and
at least one processor coupled to the memory and, based at least in part on information stored in the memory, the at least one processor is configured to:
transmit downlink control information (DCI) for a user equipment (UE) comprising at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state; and
communicate based on the one or more TCI states.

16. The apparatus of claim 15, wherein the at least one activated TCI state is based on an activation medium access control (MAC) control element (MAC-CE).

17. The apparatus of claim 16, wherein the activation MAC-CE comprises one or more fields representing an association between the at least one activated TCI state and the at least one TCI codepoint.

18. The apparatus of claim 15, wherein each TCI state of the one or more TCI states is one of: a downlink (DL) TCI state, an uplink (UL) TCI state, or a joint TCI state.

19. The apparatus of claim 18, wherein the one or more TCI states indicated by the at least one TCI codepoint comprises one or more paired DL and UL TCI states.

20. The apparatus of claim 15, wherein each TCI state of the one or more TCI states is associated with a first TRP identifier (ID) of the first TRP or a second TRP ID of the second TRP based on a TCI mapping.

21. The apparatus of claim 20, wherein the TCI mapping is implicit and based on one or more types of the one or more TCI states and an order of the one or more TCI states.

22. The apparatus of claim 21, wherein the one or more TCI states include a single joint TCI state, wherein the single joint TCI state is associated with the first TRP ID if the single joint TCI state is a first TCI state in the one or more TCI states, and wherein the single joint TCI state is associated with the second TRP ID if the single joint TCI state is not the first TCI state in the one or more TCI states.

23. The apparatus of claim 21, wherein the one or more TCI states include a first joint TCI state and a second joint TCI state, and wherein the first joint TCI state is associated with the first TRP ID and the second joint TCI state is associated with the second TRP ID.

24. The apparatus of claim 21, wherein the one or more TCI states include a first downlink (DL) TCI state and a first uplink (UL) TCI state, and wherein the first DL TCI state and the first UL TCI state are associated with the first TRP ID.

25. The apparatus of claim 20, wherein the TCI mapping is signaled for the each TCI state of the one or more TCI states based on radio resource control (RRC) configured TCI state information element (IE) or an activation medium access control (MAC) control element (MAC-CE).

26. The apparatus of claim 20, wherein the TCI mapping is signaled for the each TCI state of the one or more TCI states based on the DCI.

27. The apparatus of claim 20, wherein the TCI mapping is based on a table including a plurality of fields for at least one of: the at least one TCI codepoint, the one or more TCI states mapped to the first TRP, or the one or more TCI states mapped to the second TRP.

28. The apparatus of claim 15, further comprising at least one of a transceiver or an antenna coupled to the at least one processor.

29. A method for communication at a user equipment (UE), comprising:
receiving, from a network entity, downlink control information (DCI) comprising at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state; and
communicating, with the network entity, based on the one or more TCI states.

30. A method for communication at a network entity, comprising:
transmitting downlink control information (DCI) for a user equipment (UE) comprising at least one transmission configuration indicator (TCI) codepoint, the at least one TCI codepoint indicating one or more TCI states mapped to a first transmission reception point (TRP) associated with the network entity or a second TRP associated with the network entity, the one or more TCI states being associated with at least one activated TCI state; and
communicating based on the one or more TCI states.
